(19) United States
(12) Patent Application Publication
(10) Pub. No.: US 2024/0161368 A1
(43) Pub. Date: May 16, 2024

(54) REGENERATIVE LEARNING TO ENHANCE DENSE PREDICTION

(71) Applicant: QUALCOMM Incorporated, San Diego, CA (US)

(72) Inventors: Shubhankar Mangesh BORSE, San Diego, CA (US); Debasmit DAS, San Diego, CA (US); Hyojin PARK, San Diego, CA (US); Hong CAI, San Diego, CA (US); Risheek GARREPALLI, San Diego, CA (US); Fatih Murat PORIKLI, San Diego, CA (US)

(21) Appl. No.: 18/460,903

(22) Filed: Sep. 5, 2023

Related U.S. Application Data
(60) Provisional application No. 63/383,286, filed on Nov. 11, 2022.

(51) Int. Cl. G06T 11/60; G06T 3/40; G06T 7/12; G06T 7/50; G06V 10/44

(52) U.S. Cl. CPC G06T 11/60; G06T 3/40; G06T 7/12; G06T 7/50; G06V 10/44

(57) ABSTRACT

Certain aspects of the present disclosure provide techniques and apparatus for regenerative learning to enhance dense predictions. In one example method, an input image is accessed. A dense prediction output is generated based on the input image using a dense prediction machine learning (ML) model, and a regenerated version of the input image is generated. A first loss is generated based on the input image and a corresponding ground truth dense prediction, and a second loss is generated based on the regenerated version of the input image. One or more parameters of the dense prediction ML model are updated based on the first and second losses.

### CROSS-REFERENCE TO RELATED APPLICATION(S)

The present patent application claims the benefit of priority to U.S. Provisional Patent Application No. 63/383,286, filed Nov. 11, 2022, which is incorporated by reference herein in its entirety.

### INTRODUCTION

Aspects of the present disclosure relate to regenerative learning to enhance dense prediction using machine learning models.

In various systems, artificial neural networks can be used to identify objects and estimate the locations of those objects in captured image content and perform a variety of operations based on identifying objects and estimating the locations of those objects in the captured image content.

Dense prediction generally refers to a technique for addressing a family of problems, particularly in computer vision tasks. Dense prediction involves learning a mapping from input images to complex output structures, and may be applied in various use cases, such as semantic segmentation, depth estimation, and object detection. In such use cases, pixel-level labeling may be a primary task.

Masked image modeling (MIM) techniques may be used to learn to generate images or features by inpainting masked images (e.g., where missing or obfuscated portions of an image are filled in using machine learning). In some conventional systems, MIM is used in the pretraining phase of deep networks. However, pretraining followed by fine-tuning for specific tasks may lead to catastrophic forgetting (e.g., losing something previously learned). Moreover, in such conventional approaches, MIM models are often specialized for image and/or object classification, limiting or preventing applicability to other use cases (particularly for dense prediction tasks).

### BRIEF SUMMARY

Certain aspects provide a method, comprising: accessing an input image; generating a dense prediction output based on the input image using a dense prediction machine learning (ML) model; generating a regenerated version of the input image; generating a first loss based on the input image and a corresponding ground truth dense prediction; generating a second loss based on the regenerated version of the input image; and updating one or more parameters of the dense prediction ML model based on the first and second losses.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and apparatus comprising means for performing the aforementioned methods as well as those further described herein.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts an example architecture for training dense prediction machine learning models.

FIG. 2 depicts an example architecture for training dense prediction machine learning models using attention mechanisms.

FIG. 3 is a flow diagram depicting an example method for training dense prediction machine learning models.

FIG. 4 is a flow diagram depicting an example method for training dense prediction machine learning models using attention mechanisms.

FIG. 5 is a flow diagram depicting an example method for training a dense prediction model.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for regenerative learning to enhance dense prediction machine learning models (e.g., artificial neural networks).

In some aspects, improved learning techniques for dense prediction tasks are provided, resulting in improved machine learning models that generate more accurate, precise, and reliable dense predictions. Dense prediction generally involves generating per-pixel classification or regression results, such as semantic and panoptic class labels, depth and disparity values, and surface normal angles. Such tasks are widely used for many vision applications to understand the surrounding space in detail, such as for extended reality (XR), augmented reality (AR), virtual reality (VR), mixed reality (MR), autonomous driving, robotics, visual surveillance, and the like. Neural networks have been used in some conventional approaches to attempt to solve dense prediction tasks through a variety of architectures, data augmentations, training optimizations, and loss functions. However, dense prediction remains a difficult task, and some conventional approaches fail to achieve high accuracy and precision in the generated predictions.

Aspects of the present disclosure provide improved training of dense prediction models by leveraging conditional image regeneration as additional supervision during training. This regeneration supervision can be used to improve base networks for dense prediction tasks such as segmentation, depth estimation, and surface normal prediction. In some aspects, the machine learning system applies redaction to the input image, which removes certain structure information (e.g., by sparse sampling or selective frequency removal). A conditional regenerator, which takes the redacted image and the base network's dense predictions as input, can then be used to reconstruct the original image.

In some aspects, in the redacted image, structural attributes like boundaries are broken while semantic context is largely preserved. In order to make the regeneration feasible, the conditional generator may then rely on the structure information from another input source (e.g., the dense predictions). As such, by including this conditional regeneration objective during training, aspects of the present disclosure encourage the base network to learn to embed accurate structure in the dense predictions. As discussed below in more detail, these techniques result in a model that can generate more accurate predictions with clearer boundaries and better spatial consistency, as compared to some conventional approaches.

Generally, the techniques described herein can be applied to the training of any dense prediction models. Additionally, in some aspects, the additional supervision can be extended to incorporate an attention-based regeneration module within the dense prediction network, which may further improve prediction accuracy. In some aspects, use of regeneration loss during training can improve model accuracy substantially with no additional computational expense at inference-time, while incorporation of attention-based mechanisms can further improve accuracy with minimal additional inference-time expense.

### Example Architecture for Training Dense Prediction Machine Learning Models

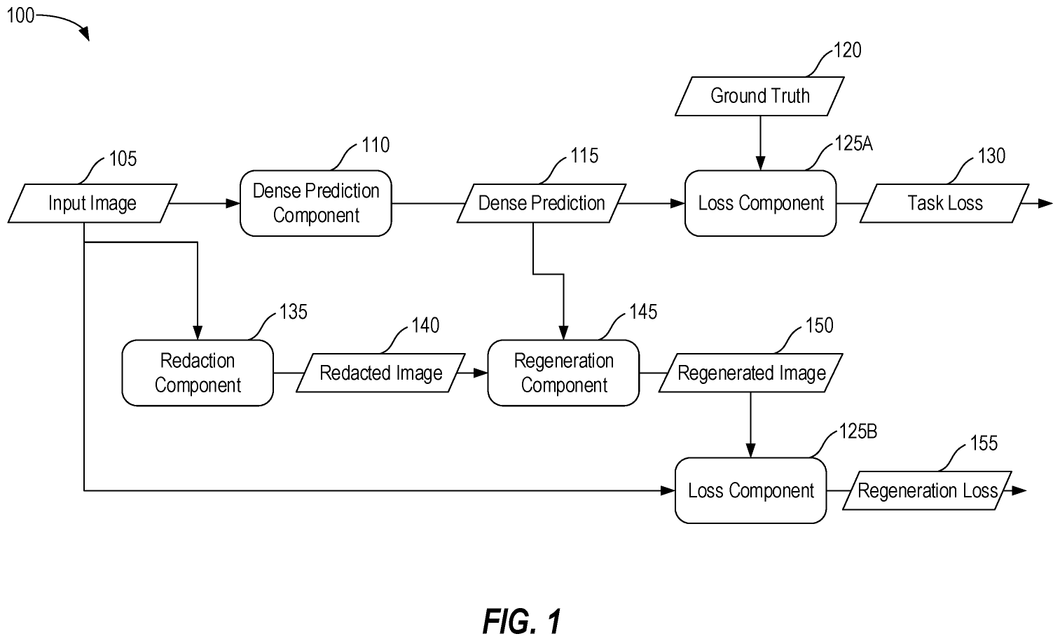

FIG. 1 depicts an example architecture 100 for training dense prediction machine learning models. In some aspects, the architecture 100 is used by a machine learning system (e.g., a training system) to train machine learning model(s) for dense prediction computer vision tasks.

In the illustrated example, a dense prediction component 110 accesses an input image 105 to generate a dense prediction 115. As used herein, “accessing” data generally includes receiving, retrieving, requesting, obtaining, generating, collecting, or otherwise gaining access to the data. In the illustrated architecture 100, the dense prediction component 110 generally corresponds to one or more machine learning models or components, such as neural network(s). The input image 105 is generally representative of any image data, and may include, for example, color images, monotone images, and the like. The input image 105 may generally correspond to a tensor having spatial dimensions (e.g., height and width of the image) and any number of channels (e.g., one channel for each component of the image).

The dense prediction component 110 may generally be used to perform any dense prediction task, such as semantic segmentation, surface normal prediction, depth estimation, and the like. In some aspects, the dense prediction 115 generally includes a prediction for each pixel in the input image 105 (e.g., a semantic class for each pixel, a depth of each pixel, and the like).

In the illustrated example, the dense prediction 115 may be accessed by a loss component 125A, which further accesses a ground truth 120 to generate a task loss 130. The ground truth 120 generally corresponds to the training label for the input image 105. For example, the ground truth 120 may include a label for one or more pixels in the input image 105, each label indicating the semantic class, depth, or other information for the corresponding pixel. The loss component 125A may generally use a variety of loss formulations to generate the task loss 130, depending on the particular implementation. For example, the loss component 125A may compute cross-entropy loss between the ground truth 120 and the dense prediction 115 (e.g., if the task is semantic segmentation), L1 (e.g., absolute error loss, also referred to as mean absolute error) for depth estimation tasks, and the like. The task loss 130 may be used to update the parameter(s) of the dense prediction component 110, as discussed in more detail below.

In the illustrated architecture 100, the input image 105 is further provided to a redaction component 135. The redaction component 135 may perform one or more redaction or occlusion operations to generate a redacted image 140. Generally, the redaction component 135 may use a variety of techniques and operations to generate the redacted image 140. For example, in some aspects, the redaction component 135 uses spatial redaction by removing or occluding one or more pixels (or setting one or more pixels to a defined value, such as zero) from the input image 105. Generally, such spatial redaction may include a variety of operations, such as random redaction (e.g., redacting pixels in random locations), checkerboard redaction (e.g., delineating the pixels into blocks of multiple pixels, and redacting alternating blocks in a checkerboard approach), random checkerboard redaction (e.g., randomly redacting blocks from the delineated blocks), and the like.

In some aspects, the redaction component 135 performs frequency redaction to remove one or more frequency bands from the input image 105. For example, in some aspects, the redaction component 135 converts the input image 105 to the frequency domain (e.g., using a discrete cosine transform (DCT)), and removes one or more specific frequency components to redact the one or more frequency bands. The data can then be converted back to the spatial domain to generate the redacted image 140. In some aspects, the redaction component 135 redacts one or more high-frequency components (e.g., frequency bands nearer to the top of the spectrum) which may effectively remove information relating to object structure or shape (e.g., boundaries between depicted objects). In some aspects, the redaction component 135 may additionally or alternative redact one or more low-frequency components (e.g., frequency bands nearer to the bottom of the spectrum), which may remove information relating to object size from the image.

In some aspects, the redaction component 135 may perform size-based redaction, such as by reducing the resolution of the input image 105 to generate the redacted image 140.

In the illustrated architecture 100, the redacted image 140 is accessed by a regeneration component 145, which further accesses the dense prediction 115 to generate a regenerated image 150. In some aspects, the regeneration component 145 generates the regenerated image 150 by conditioning the redacted image 140 using the dense prediction 115, and using this conditioned redacted image as input to a machine learning model (e.g., a small convolutional neural network). The regeneration component 145 may condition the redacted image 140 using a variety of operations, depending on the particular implementation.

For example, in some aspects, the regeneration component 145 conditions the redacted image 140 based on the dense prediction 115 using multiplication (e.g., by casting the dense prediction 115 to have the same spatial size and depth as the redacted image 140, and performing element-wise multiplication to generate the conditioned redacted image. In some aspects, the regeneration component 145 conditions the redacted image 140 based on the dense prediction 115 using concatenation (e.g., concatenating the dense prediction 115 and the redacted image 140 along the channel or depth dimension). In some aspects, the regeneration component 145 conditions the redacted image 140 based on the dense prediction 115 using channel pooling (e.g., by pooling or averaging the dense prediction 115 and the redacted image 140 along the channel or depth dimension).

As illustrated, the regenerated image 150 is accessed by a loss component 125B, which also accesses the original input image 105 to generate a regeneration loss 155. The loss component 125B may generally use a variety of loss formulations to generate the regeneration loss 155, depending on the particular implementation. For example, the loss component 125B may compute a mean squared error loss based on the regenerated image 150 and the input image 105. In some aspects, the loss component 125B uses perceptual metrics, such as Learned Perceptual Image Patch Similarity (LPIPS) to compute the regeneration loss 155. The regeneration loss 155 may be used to update the parameters of the regeneration component 145 and/or dense prediction component 110, as discussed in more detail below.

In some aspects, the task loss 130 is used to update the model(s) used by the dense prediction component 110, such as via backpropagation. In some aspects, the regeneration loss 155 can similarly be backpropagated through the regeneration component 145 to update the parameter(s) of the regeneration model, and then through the dense prediction component 110 to update the parameters of the dense prediction model. In some aspects, the architecture 100 may train the dense prediction component 110 based on an overall or total loss [symbol] defined using Equation 1 below, where [symbol] ₜₐₛₖ is the task loss 130 (e.g., cross-entropy loss), [symbol] _{regen} is the regeneration loss 155, and γ is a hyperparameter to weight the losses:

[symbol]

= [symbol] ₜₐₛₖ+γ [symbol] _{regen} (1)

Further, the regeneration loss 155 may be defined using Equation 2 below, where [symbol] _{LPIPS} is one component of the regeneration loss 155 (e.g., LPIPS loss), [symbol] _{MSE} is a second component of the regeneration loss 155 (e.g., mean squared error), and γ₁ and γ₂ are hyperparameters to weight the losses:

[symbol]

_{regen}=γ₁ [symbol] _{LPIPS}+γ₂ [symbol] _{MSE} (2)

In the illustrated example, the task loss 130 and regeneration loss 155 may be used to refine the parameters of the dense prediction component 110 and/or regeneration component 145. Although the illustrated example depicts generating the task loss 130 and regeneration loss 155 based on a single input image 105 (e.g., using stochastic gradient descent), in some aspects, the machine learning system may compute task loss 130 and regeneration loss 155 based on multiple input images (e.g., using batch gradient descent), updating the model(s) based on batches of training data.

As discussed above, the regeneration loss 155 can substantially improve the accuracy of the dense prediction component 110, allowing the dense prediction component 110 to generate more accurate and precise dense predictions 115 during inferencing. In some aspects, to use the model(s) during inferencing, input images may be processed using the dense prediction component 110 to generate corresponding dense prediction outputs, and the loss component 125A, loss component 125B, redaction component 135, and regeneration component 145 may be unused or not present.

### Example Architecture for Training Dense Prediction Machine Learning Models Using Attention Mechanisms

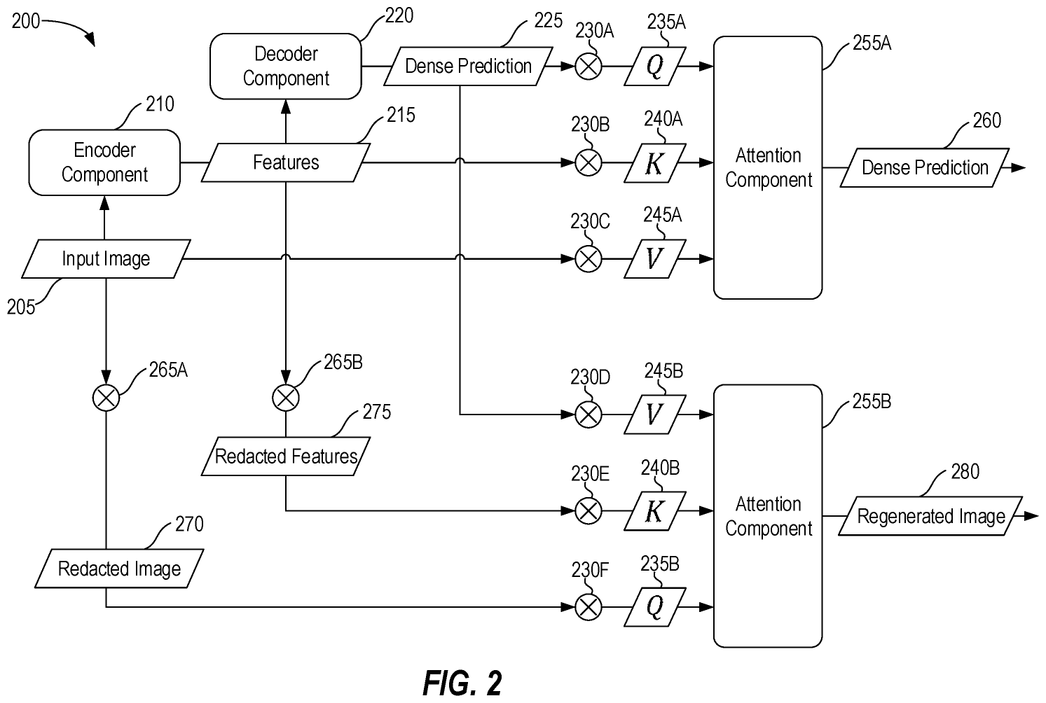

FIG. 2 depicts an example architecture 200 for training dense prediction machine learning models using attention mechanisms (e.g., in a transformer architecture). In some aspects, the architecture 200 provides additional detail for portions of the architecture 100 of FIG. 1. For example, as discussed in more detail below, the encoder component 210, decoder component 220, and attention component 255A may be subcomponents of the dense prediction component 110 of FIG. 1, while the attention component 255B may be a subcomponent of the regeneration component 145 of FIG. 1. In some aspects, the architecture 200 is used by a machine learning system (e.g., a training system) to train machine learning model(s) for dense prediction computer vision tasks, such as the machine learning system discussed above with reference to FIG. 1.

In the illustrated example, an input image 205 is accessed by an encoder component 210 to generate a set of features 215. As illustrated, the input image 205 is further accessed by an operation 230C and operation 265A, each of which is discussed in more detail below. In some aspects, the input image 205 corresponds to the input image 105 of FIG. 1. The input image 205 is generally representative of any image data, and may include, for example, color images, monotone images, and the like. In some aspects, the encoder component 210 comprises all or a portion of a machine learning model (e.g., a neural network). For example, if the dense prediction task is performed by an encoder-decoder neural network architecture (where input images are processed using an encoder to generate latent features, which are then processed by a decoder to generate the target output), the encoder component 210 may correspond to the encoder layer(s) or subnet of the model.

The features 215 are generally representative of the latent features of the input image 205, as generated by the encoder component 210. As illustrated, the features 215 are accessed by a decoder component 220, which processes the features 215 to generate a dense prediction 225 (also referred to as a dense prediction mask, a first dense prediction, and/or an interim or intermediate dense prediction in some aspects). In some aspects, the decoder component 220 corresponds to the decoder layer(s) or subnet of an encoder-decoder architecture, as discussed above. In some aspects, the dense prediction 225 may include pixel-level classifications or regression values. In some aspects, the dense prediction 225 may correspond to the dense prediction 115 of FIG. 1 (which may be used to generate the regeneration loss, as discussed in more detail below), and the final output of the dense prediction component may correspond to the dense prediction 260, which is generated based on further processing of the dense prediction 225 (as discussed in more detail below).

As illustrated, the dense prediction 225 is accessed by an operation 230A, which processes the dense prediction 225 to generate a query tensor 235A (also referred to as a query matrix, or simply as queries or a set of queries, in some aspects). In some aspects, the operation 230A comprises multiplying the dense prediction 225 with a set of one or more learned weights to generate the query tensor 235A. For example, the query weight(s) used by the operation 230A may be learned during training (e.g., via backpropagation).

As illustrated, the query tensor 235A is used as one input to an attention mechanism (e.g., the attention component 255A). In the illustrated example, the attention component 255A uses three inputs: a query tensor 235A, a key tensor 240A (also referred to in some aspects as a key matrix, keys, or a set of keys), and a value tensor 245A (also referred to in some aspects as a value matrix, values, or a set of values) and generates a dense prediction 260 (referred to in some aspects as a final or output dense prediction for the input image 205).

In the depicted example, the key tensor 240A is generated by operation 230B based on the features 215. For example, in some aspects, the operation 230B comprises multiplying the features 215 with a set of one or more learned key weights to generate the key tensor 240A. Further, the value tensor 245A is generated by operation 230C based on the input image 205. For example, in some aspects, the operation 230C comprises multiplying the input image 205 with a set of one or more learned value weights to generate the value tensor 245A. In some aspects, rather than using the features 215 to generate the key tensor 240A, the operation 230B may use the input image 205. That is, the input image 205 may be used to generate the key tensor 240A and value tensor 245A (using separate learned weights for each), while the features 215 are used to generate the dense prediction 225 (which is used to generate the query tensor 235A).

In the illustrated aspect, the attention component 255A generates the dense prediction 260 by applying an attention mechanism to the query tensor 235A, key tensor 240A, and value tensor 245A. For example, in some aspects, the attention component 255A may use matrix multiplication to multiply the query tensor 235A and the key tensor 240A (or to multiply the query tensor 235A and the transpose of the key tensor 240A), and multiplying this resulting matrix by the value tensor 245A. In some aspects, the attention component 255BA may use other operations to process the input tensors, such as using one or more layers of a neural network (e.g., a fully connected layer). In some aspects, the attention component 255A may then apply one or more activation functions, such as the softmax function, to generate the dense prediction 260.

The dense prediction 260 generally includes a prediction for each pixel in the input image 205, where the specific prediction may vary depending on the particular implementation (e.g., a semantic class for each pixel, a depth of each pixel, and the like). For example, the dense prediction 260 may correspond to the dense prediction 115 of FIG. 1. In some aspects, the dense prediction 260 may be used to compute a task loss (e.g., task loss 130 of FIG. 1) for the model. For example, as discussed above, the dense prediction 260 may be compared with a ground truth label for the input image 205 to generate a task loss (e.g., using cross-entropy). This task loss may then be used to update the parameters of the model (e.g., the parameters of the attention component 255A, the weights used by the operations 230A, 230B and 230C, as well as the parameters of the decoder component 220 and the encoder component 210), such as using backpropagation.

In the illustrated example, the input image 205 is further accessed by the operation 265A, which performs image redaction to generate a redacted image 270. In some aspects, the operation 265A may correspond to the redaction component 135 of FIG. 1. Generally, the particular redaction operation(s) applied may vary depending on the particular implementation. For example, as discussed above, the operation 265A may include random spatial redaction (e.g., redacting randomly selected pixels), structured spatial redaction (e.g., redacting specific blocks of pixels, such as alternating blocks in a checkerboard pattern), random frequency redaction (e.g., converting the input image 205 to the frequency domain and redacting one or more randomly selected frequency bands), structured frequency redaction (e.g., converting the input image 205 to the frequency domain and redacting one or more specific frequency bands), reduced resolution of the input image 205, and the like.

As illustrated, the redacted image 270 is used by operation 230F to generate a query tensor 235B. For example, as discussed above, the operation 230F may include multiplying the redacted image 270 by one or more learned weights to generate the query tensor 235B, which is used as input to an attention component 255B.

Additionally, in the illustrated example, the features 215 are further accessed by an operation 265B, which performs feature redaction to generate a set of redacted features 275. In some aspects, the operation 265B may similarly correspond to the redaction component 135 of FIG. 1. Generally, the particular redaction operation(s) applied may vary depending on the particular implementation. For example, as discussed above, the operation 265B may include random and/or structured spatial redaction, random and/or structured frequency redaction, reduced resolution of the features 215, and the like.

As illustrated, the redacted features 275 are used by an operation 230E to generate a key tensor 240B. For example, as discussed above, the operation 230E may include multiplying the redacted features 275 by one or more learned weights to generate the key tensor 240B, which is used as input to an attention component 255B. Although the illustrated example depicts use of the redacted features 275 to generate the key tensor 240B, in some aspects, the machine learning system may alternatively use the dense prediction 225 (with or without redaction). For example, in some aspects, the key tensor 240B may be generated by multiplying the dense prediction 225 (or a redacted version of the dense prediction 225) with one or more learned weights.

In the illustrated example, the dense prediction 225 is accessed by an operation 230D to generate a value tensor 245B. For example, as discussed above, the operation 230D may include multiplying the dense prediction 225 by one or more learned weights to generate the value tensor 245B, which is used as input to an attention component 255B.

In the illustrated aspect, the attention component 255B generates a regenerated image 280 by applying an attention mechanism to the query tensor 235B, key tensor 240B, and value tensor 245B. For example, in some aspects, the attention component 255B may use matrix multiplication to multiply the query tensor 235B and the key tensor 240B (or to multiply the query tensor 235B and the transpose of the key tensor 240B), and may further multiply this resulting matrix by the value tensor 245B. In some aspects, the attention component 255B may use other operations to process the input tensors, such as using one or more layers of a neural network (e.g., a fully connected layer). In some aspects, the attention component 255B may then apply one or more activation functions, such as the softmax function, to generate the regenerated image 280.

The regenerated image 280 generally corresponds to a reproduction of the input image 205, as discussed above. For example, the regenerated image 280 may correspond to the regenerated image 150 of FIG. 1. In some aspects, the regenerated image 280 may be used to compute a regeneration loss for the model. For example, as discussed above, the regenerated image 280 may be compared with the input image 205 to generate the regeneration loss (e.g., using mean squared error, LPIPS, and the like). This regeneration loss may then be used to update the parameters of the model (e.g., the parameters of the attention component 255B, the weights used by the operations 230D, 230E and 230F, as well as the parameters of the decoder component 220 and/or the encoder component 210), such as using backpropagation.

During inferencing, dense predictions may be generated using the encoder component 210, decoder component 220, and attention component 255A (e.g., the attention component 255B may be unused or not present).

Although the illustrated example depicts two discrete attention components 255A and 255B (collectively, the attention components 255) for conceptual clarity, in some aspects, the attention components 255A and 255B may use a shared architecture and/or set of parameters. For example, for each training round and/or for each input image 205 used during training, the machine learning system may perform two iterations: a first iteration where the attention component is used to generate the dense prediction 260, and a second iteration where the same attention component is used to process the previously generated data in order to generate the regenerated image 280. Similarly, the operation 230A may correspond to or use shared parameters with the operation 230F, the operation 230B may correspond to or use shared parameters with the operation 230E, and the operation 230C may correspond to or use shared parameters with the operation 230D. In some aspects, the attention components 255 may be implemented using one or more multi-headed attention modules.

As discussed above, the architecture 200 may generally be updated based on the task loss and regeneration loss based on individual input images (e.g., using stochastic gradient descent) and/or based on multiple input images (e.g., using batch gradient descent). As discussed above, the use of regeneration loss can substantially improve the accuracy of the dense predictions. Additionally, by using the attention-based mechanisms of the architecture 200, the regenerative learning can be further enhanced, resulting in additional improved accuracy of the trained models (e.g., improved dense predictions 260 generated by the encoder component 210, decoder component 220, and attention component 255A).

### Example Method for Training Dense Prediction Machine Learning Models

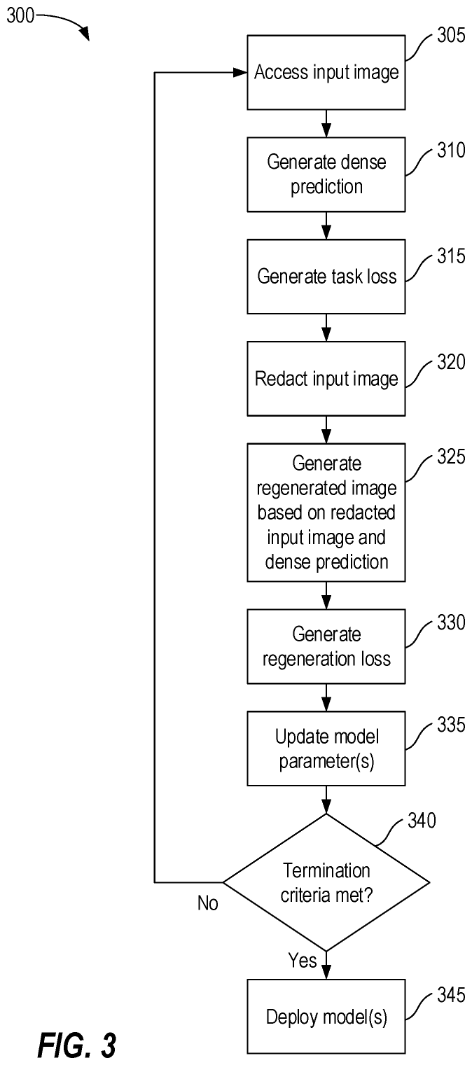

FIG. 3 is a flow diagram depicting an example method 300 for training dense prediction machine learning models. In some aspects, the method 300 is performed by a machine learning system (e.g., a training system) to train machine learning model(s) for dense prediction computer vision tasks, such as using the architecture 100 of FIG. 1 and/or the architecture 200 of FIG. 2.

At block 305, the machine learning system accesses an input image (e.g., input image 105 of FIG. 1, and/or input image 205 of FIG. 2). As discussed above, the input image generally corresponds to an image depicting a physical scene, such as used for self-driving or autonomous navigation. For example, the image may be captured by an autonomous vehicle, and depict the environment around the vehicle (e.g., the road and one or more obstacles, such as other vehicles).

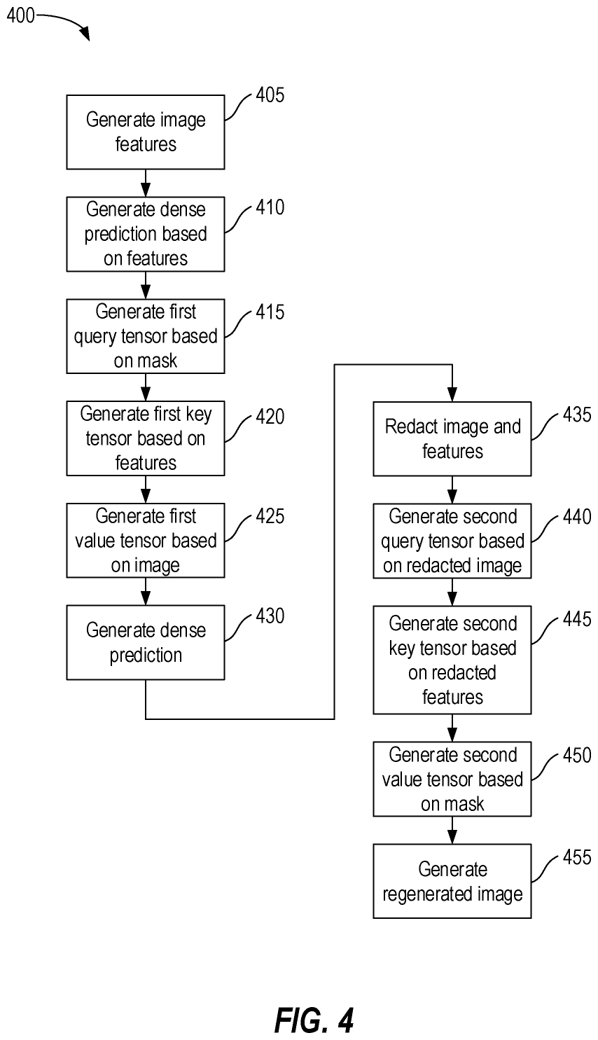

At block 310, the machine learning system generates a dense prediction (e.g., dense prediction 115 of FIG. 1, dense prediction 225 of FIG. 2, and/or dense prediction 260 of FIG. 2) based on the input image. For example, as discussed above, the machine learning system may use one or more machine learning models or components to generate, for each respective pixel in the input image, a respective label indicating one or more respective class(es) and/or respective regression value(s) for the respective pixel. As discussed above, the particular contents of the dense prediction may vary depending on the particular implementation. In some aspects, the machine learning system generates the dense prediction using a convolutional neural network, as discussed above with reference to FIG. 1. In some aspects, the machine learning system generates the dense prediction using an attention-based mechanism, as discussed above with reference to FIG. 2 and in more detail below with reference to FIG. 4.

At block 315, the machine learning system generates a task loss (e.g., task loss 130 of FIG. 1) based on the dense prediction. For example, as discussed above, the machine learning system may access a ground truth label (e.g., indicating pixel-level labels for one or more pixels in the input image) and compute a task loss based on difference(s) between the dense prediction and the ground truth (e.g., using cross-entropy loss).

At block 320, the machine learning system redacts the input image to generate a redacted version of the input image (e.g., redacted image 140 of FIG. 1 and/or redacted image 270 of FIG. 2). For example, as discussed above, redacting the image may include use of random or structured spatial redaction (e.g., occluding one or more pixels in the image), random or structured frequency redaction (e.g., redacting one or more frequency bands), converting the image to a lower resolution as compared to the input image, and the like.

At block 325, the machine learning system generates a regenerated version of the input image (e.g., regenerated image 150 of FIG. 1 and/or regenerated image 280 of FIG. 2) based on the redacted input image and the dense prediction. For example, as discussed above, the machine learning system may condition the redacted image based on the dense prediction and process the (conditioned) redacted image using a convolutional neural network (as discussed above with reference to FIG. 1), and/or may use an attention-based mechanism to generate the regenerated image (as discussed above with reference to FIG. 2 and in more detail below with reference to FIG. 4).

At block 330, the machine learning system generates a regeneration loss (e.g., regeneration loss 155 of FIG. 1) based on the regenerated image. For example, as discussed above, the machine learning system may compute the regeneration loss based on difference(s) between the regenerated image and the original input image (e.g., using mean squared error loss and/or LPIPS loss).

At block 335, the machine learning system updates the parameters of one or more machine learning models based on the task loss and the regeneration loss. For example, as discussed above, the machine learning system may backpropagate the regeneration loss through the regeneration model (e.g., the regeneration component 145 of FIG. 1 or the attention component 255B and/or the operations 230D, 230E, and 230F, each of FIG. 2). In some aspects, the machine learning system may further backpropagate the regeneration loss (via the regeneration model) through the dense prediction model (e.g., the dense prediction component 110 of FIG. 1 or the decoder component 220 and encoder component 210, each of FIG. 2). Further, in some aspects, the machine learning system may backpropagate the task loss through the dense prediction model (e.g., the dense prediction component 110 of FIG. 1 or the attention component 255A and/or the operations 230A, 230B, and 230C, each of FIG. 2).

Although the illustrated example depicts updating the model parameters based on a single input image (e.g., using stochastic gradient descent), in some aspects, the machine learning system may compute task loss and regeneration loss based on multiple input images (e.g., using batch gradient descent), updating the model(s) based on batches of training data.

At block 340, the machine learning system determines whether one or more training termination criteria are met. Generally, the particular termination criteria may vary depending on the particular implementation. For example, the machine learning system may determine whether additional training exemplars remain, whether a defined number of iterations or epochs have been completed, whether a defined time or amount of resources have been spent training, whether the model has reached a desired minimum accuracy, and the like.

If, at block 340, the machine learning system determines that the criteria are not met, the method 300 returns to block 305. If the machine learning system determines that the termination criteria are met, the method 300 continues to block 345, where the machine learning system deploys the trained dense prediction model(s).

Generally, deploying the model may include a wide variety of actions and operations to provide the model for inferencing. For example, the machine learning system may compile the model (e.g., compiling the weights and other parameters into a single file or data structure), transmit the model to a second system (e.g., to a dedicated inferencing system), instantiate the model locally (e.g., if the machine learning system also performs inferencing), and the like.

### Example Method for Training Dense Prediction Machine Learning Models Using Attention Mechanisms

FIG. 4 is a flow diagram depicting an example method 400 for training dense prediction machine learning models using attention mechanisms. In some aspects, the method 400 is performed by a machine learning system (e.g., a training system) to train machine learning model(s) for dense prediction computer vision tasks, such as using the architecture 100 of FIG. 1 and/or the architecture 200 of FIG. 2. In some aspects, the method 400 provides additional detail for portions of the method 300 of FIG. 3. For example, blocks 405, 410, 415, 420, and 430 may correspond to block 310 of FIG. 3, and blocks 435, 440, 445, 450, and 455 may correspond to block 325 of FIG. 3.

At block 405, the machine learning system generates image features (e.g., the features 215 of FIG. 2) based on the input image. For example, as discussed above, the machine learning system may process the input image using a portion of an encoder-decoder model (e.g., using the encoder component 210 of FIG. 2) to generate the features. In some aspects, as discussed above, the set of features may be referred to as a latent tensor representing the input image.

At block 410, the machine learning system generates a first dense prediction (e.g., the dense prediction 225 of FIG. 2) based on the features. For example, as discussed above, the machine learning system may process the features 215 using a portion of an encoder-decoder model (e.g., using the decoder component 220 of FIG. 2) to generate the first dense prediction. In some aspects, as discussed above, the first dense prediction may alternatively be referred to as a dense prediction mask and/or as an interim or intermediate dense prediction.

At block 415, the machine learning system generates a first query tensor (e.g., the query tensor 235A of FIG. 2) based on the dense prediction. For example, as discussed above, the machine learning system may multiply the dense prediction using one or more learned query weights to generate the first query tensor.

At block 420, the machine learning system generates a first key tensor (e.g., the key tensor 240A of FIG. 2) based on the set of features. For example, as discussed above, the machine learning system may multiply the features using one or more learned key weights to generate the first key tensor. In some aspects, as discussed above, the machine learning system may alternatively generate the first key tensor based on the input image (e.g., by multiplying the input image using one or more learned key weights to generate the first key tensor).

At block 425, the machine learning system generates a first value tensor (e.g., the value tensor 245A of FIG. 2) based on the input image. For example, as discussed above, the machine learning system may multiply the image using one or more learned value weights to generate the first value tensor.

At block 430, the machine learning system then generates a second dense prediction (e.g., the dense prediction 260 of FIG. 2) based on the first query tensor, the first value tensor, and the first key tensor. For example, as discussed above, the machine learning system may use an attention mechanism (e.g., the attention component 255A of FIG. 2) to process the first query tensor, the first key tensor, and the first value tensor in order to generate the dense prediction. In some aspects, this second dense prediction is referred to as the output or final dense prediction for the input image.

At block 435, the machine learning system redacts the input image and/or features (e.g., to generate the redacted image 270 and the redacted features 275, each of FIG. 2, respectively). For example, as discussed above, the machine learning system may use random and/or structured spatial redaction or occlusion, random and/or structured frequency redaction, resolution reduction, and the like. Although the illustrated example depicts redacting both the image and the features, in some aspects, the machine learning system may redact only the image (e.g., if the features are not used to generate the regenerated image), as discussed above.

At block 440, the machine learning system generates a second query tensor (e.g., the query tensor 235B of FIG. 2) based on the redacted image. For example, as discussed above, the machine learning system may multiply the redacted image using one or more learned query weights to generate the second query tensor.

At block 445, the machine learning system generates a second key tensor (e.g., the key tensor 240B of FIG. 2) based on the redacted set of features. For example, as discussed above, the machine learning system may multiply the redacted features using one or more learned key weights to generate the second key tensor. In some aspects, as discussed above, the machine learning system may alternatively generate the second key tensor based on the generated dense prediction (e.g., by multiplying the first dense prediction using one or more learned key weights to generate the second key tensor).

At block 450, the machine learning system generates a second value tensor (e.g., the value tensor 245B of FIG. 2) based on the first dense prediction. For example, as discussed above, the machine learning system may multiply the dense prediction using one or more learned value weights to generate the second value tensor.

At block 455, the machine learning system then generates a regenerated image (e.g., the regenerated image 280 of FIG. 2) based on the second query tensor, the second value tensor, and the second key tensor. For example, as discussed above, the machine learning system may use an attention mechanism (e.g., the attention component 255B of FIG. 2) to process the second query tensor, the second key tensor, and the second value tensor in order to generate the regenerated version of the input image.

In some aspects, as discussed above, the machine learning system may use a shared attention mechanism for the dense prediction and the regenerated image. For example, the machine learning system may use the attention mechanism during a first iteration (when the dense prediction is used to generate the queries) to generate the dense prediction, and may use the attention mechanism during a subsequent (e.g., second) iteration (when the image is used to generate the queries) to generate the regenerated image.

Using the method 400, the machine learning system may train the dense prediction model(s) to generate accurate dense predictions based on the regeneration loss and attention mechanism(s), as discussed above.

### Example Method for Training a Dense Prediction Model

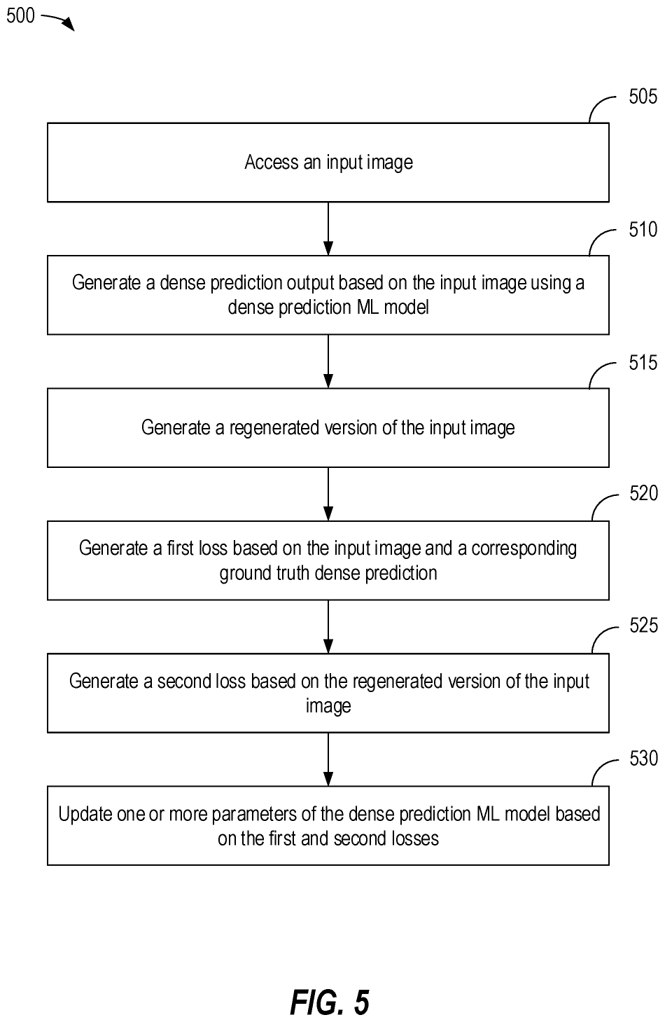

FIG. 5 is a flow diagram depicting an example method 500 for training a dense prediction model. In some aspects, the method 500 is performed by a machine learning system (e.g., a training system) to train machine learning model(s), such as using the architecture 100 of FIG. 1 and/or the architecture 200 of FIG. 2.

At block 505, an input image is accessed.

At block 510, a dense prediction output is generated based on the input image using a dense prediction machine learning (ML) model. In some aspects, the dense prediction output comprises at least one of a semantic segmentation output, a depth estimation output, or a surface normal estimation output.

At block 515, a regenerated version of the input image is generated. In some aspects, generating the regenerated version of the input image comprises: generating a redacted version of the input image and generating, using a regeneration model, the regenerated version of the input image based on the redacted version of the input image and the dense prediction output. In some aspects, the method 500 further includes updating one or more parameters of the regeneration model based on the second loss. In some aspects, generating the redacted version of the input image comprises at least one of: redacting one or more frequency bands of the input image, occluding one or more pixels of the input image, or generating a lower image resolution version of the input image, as compared to an original image resolution of the input image. In some aspects, the regeneration model is trained to regenerate the input image by processing the redacted version of the input image conditioned on the dense prediction output.

At block 520, a first loss is generated based on the input image and a corresponding ground truth dense prediction.

At block 525, a second loss is generated based on the regenerated version of the input image.

At block 530, one or more parameters of the dense prediction ML model are updated based on the first and second losses. In some aspects, the dense prediction ML model comprises a multi-head attention module that generates the dense prediction output based on the input image, a set of features extracted from the input image, and a dense prediction mask generated based on the set of features.

In some aspects, generating the dense prediction output comprises: generating a first query matrix based on the dense prediction mask, generating a first key matrix based on the set of features, generating a first value matrix based on the input image, and generating the dense prediction output based on the first query matrix, the first key matrix, and the first value matrix.

In some aspects, generating the regenerated version of the input image comprises: generating a second query matrix based on a redacted version of the input image, generating a second key matrix based on a redacted version of the set of features, generating a second value matrix based on the dense prediction mask, and generating the regenerated version of the input image based on the second query matrix, the second key matrix, and the second value matrix.

### Example Processing Systems for Regenerative Learning to Enhance Dense Prediction

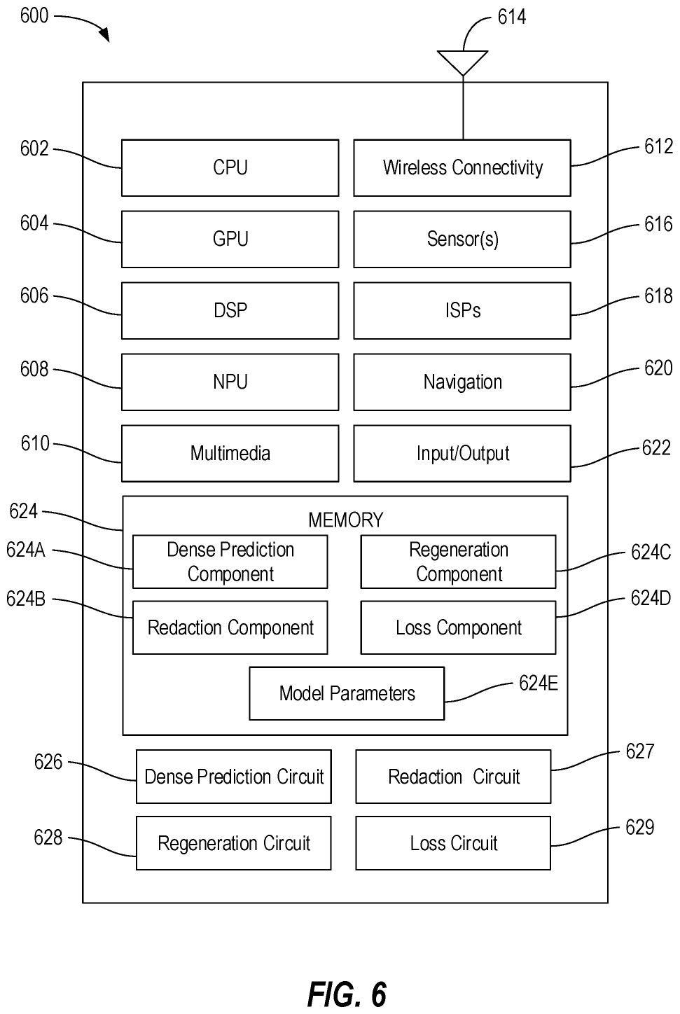

In some aspects, the workflows, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In some aspects, the processing system 600 may correspond to a machine learning system, such as the machine learning system discussed above with reference to FIGS. 1-5. For example, the processing system 600 may correspond to a system that trains machine learning models using regenerative learning. In some aspects, as discussed above, the processing system 600 may additionally use trained models (trained using regenerative learning) for inferencing. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a dense prediction component 624A, a redaction component 624B, a regeneration component 624C, and a loss component 624D. The memory 624 further includes model parameters 624E for one or more models (e.g., parameters of dense prediction models and/or regeneration models). Although not included in the illustrated example, in some aspects the memory 624 may also include other data, such as training data (e.g., to train and/or fine-tune the model(s)). Though depicted as discrete components for conceptual clarity in FIG. 6, the illustrated components (and others not depicted) may be collectively or individually implemented in various aspects.

The processing system 600 further comprises a dense prediction circuit 626, a redaction circuit 627, a regeneration circuit 628, and a loss circuit 629. The depicted circuits, and others not depicted, may be configured to perform various aspects of the techniques described herein.

For example, the dense prediction component 624A and/or the dense prediction circuit 626 (which may correspond to the dense prediction component 110 of FIG. 1 and/or the encoder component 210, the decoder component 220, the operations 230A, 230B, and 230C, and the attention component 255A, each of FIG. 2) may be used to generate dense predictions (e.g., pixel-level predictions) based on processing input images using machine learning, as discussed above. For example, the dense prediction component 624A and/or the dense prediction circuit 626 may use machine learning models (which may include attention mechanisms, as discussed above) to generate dense predictions. As discussed above, these dense predictions may be used to generate task losses, as well as regenerated images (which can be used to generate regeneration loss), which enable the models to learn to generate more accurate and reliable dense predictions over time.

The redaction component 624B and/or the redaction circuit 627 (which may correspond to the redaction component 135 of FIG. 1 and/or the operations 265A and 265B of FIG. 2) may be used to redact input images and/or features, as discussed above. For example, the redaction component 624B and/or the redaction circuit 627 may redact frequency bands, redact or occlude pixels, and/or reduce the resolution of input images to enable generation of regenerated images.

The regeneration component 624C and/or the regeneration circuit 628 (which may correspond to the regeneration component 145 of FIG. 1 and/or the operations 230D, 230E, and 230F, and the attention component 255B, each of FIG. 2) may be used to generate regenerated versions of input images, as discussed above. For example, the regeneration component 624C and/or the regeneration circuit 628 may generate regenerated images based on the redacted image and conditioned on dense predictions, as discussed above. These regenerated images can be used to generate regeneration loss, which can substantially improve the model performance, as discussed above.

The loss component 624D and/or the loss circuit 629 (which may correspond to the loss components 125A and 125B of FIG. 1) may be used to generate losses (such as the task loss 130 and the regeneration loss 155, each of FIG. 1), as discussed above. For example, the loss component 624D and/or the loss circuit 629 may process the dense predictions to generate task loss (e.g., based on a ground truth label for the image), and process the regenerated image to generate regeneration loss (e.g., based on the original input image).

Though depicted as separate components and circuits for clarity in FIG. 6, the dense prediction circuit 626, the redaction circuit 627, the regeneration circuit 628, and the loss circuit 629 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Clause 1: A method, comprising: accessing an input image; generating a dense prediction output based on the input image using a dense prediction machine learning (ML) model; generating a regenerated version of the input image; generating a first loss based on the input image and a corresponding ground truth dense prediction; generating a second loss based on the regenerated version of the input image; and updating one or more parameters of the dense prediction ML model based on the first and second losses.

Clause 2: The method of Clause 1, wherein generating the regenerated version of the input image comprises: generating a redacted version of the input image; and generating, using a regeneration model, the regenerated version of the input image based on the redacted version of the input image and the dense prediction output.

Clause 3: The method of Clause 2, further comprising updating one or more parameters of the regeneration model based on the second loss.

Clause 4: The method of any of Clauses 2-3, wherein generating the redacted version of the input image comprises at least one of: redacting one or more frequency bands of the input image, occluding one or more pixels of the input image, or generating a lower image resolution version of the input image, as compared to an original image resolution of the input image.

Clause 5: The method of any of Clauses 2-4, wherein the regeneration model is trained to regenerate the input image by processing the redacted version of the input image conditioned on the dense prediction output.

Clause 6: The method of any of Clauses 1-5, wherein the dense prediction output comprises at least one of a semantic segmentation output, a depth estimation output, or a surface normal estimation output.

Clause 7: The method of any of Clauses 1-6, wherein the dense prediction ML model comprises a multi-head attention module that generates the dense prediction output based on the input image, a set of features extracted from the input image, and a dense prediction mask generated based on the set of features.

Clause 8: The method of Clause 7, wherein generating the dense prediction output comprises: generating a first query matrix based on the dense prediction mask; generating a first key matrix based on the set of features; generating a first value matrix based on the input image; and generating the dense prediction output based on the first query matrix, the first key matrix, and the first value matrix.

Clause 9: The method of Clause 8, wherein generating the regenerated version of the input image comprises: generating a second query matrix based on a redacted version of the input image; generating a second key matrix based on a redacted version of the set of features; generating a second value matrix based on the dense prediction mask; and generating the regenerated version of the input image based on the second query matrix, the second key matrix, and the second value matrix.

Clause 10: A system comprising: a memory having executable instructions stored thereon; and a processor configured to execute the executable instructions to cause the system to perform the operations of any of Clauses 1-9.

Clause 11: A system comprising means for performing the operations of any of Clauses 1-9.

Clause 12: A computer-readable medium having instructions stored thereon which, when executed by a processor, perform the operations of any of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising computer-executable instructions; and
one or more processors configured to execute the computer-executable instructions and cause the processing system to:
access an input image;
generate a dense prediction output based on the input image using a dense prediction machine learning (ML) model;
generate a regenerated version of the input image;
generate a first loss based on the input image and a corresponding ground truth dense prediction;
generate a second loss based on the regenerated version of the input image; and
update one or more parameters of the dense prediction ML model based on the first and second losses.

2. The processing system of claim 1, wherein, to generate the regenerated version of the input image, the one or more processors are further configured to execute the computer-executable instructions to cause the processing system to:
generate a redacted version of the input image; and
generate, using a regeneration model, the regenerated version of the input image based on the redacted version of the input image and the dense prediction output.

3. The processing system of claim 2, wherein the one or more processors are further configured to execute the computer-executable instructions to cause the processing system to update one or more parameters of the regeneration model based on the second loss.

4. The processing system of claim 2, wherein, to generate the redacted version of the input image, the one or more processors are further configured to execute the computer-executable instructions to cause the processing system to:
redact one or more frequency bands of the input image,
occlude one or more pixels of the input image, or
generate a lower image resolution version of the input image, as compared to an original image resolution of the input image.

5. The processing system of claim 2, wherein the regeneration model is trained to regenerate the input image by processing the redacted version of the input image conditioned on the dense prediction output.

6. The processing system of claim 1, wherein the dense prediction output comprises at least one of a semantic segmentation output, a depth estimation output, or a surface normal estimation output.

7. The processing system of claim 1, wherein the dense prediction ML model comprises a multi-head attention module that generates the dense prediction output based on the input image, a set of features extracted from the input image, and a dense prediction mask generated based on the set of features.

8. The processing system of claim 7, wherein, to generate the dense prediction output, the one or more processors are further configured to execute the computer-executable instructions to cause the processing system to:
generate a first query matrix based on the dense prediction mask;
generate a first key matrix based on the set of features;
generate a first value matrix based on the input image; and
generate the dense prediction output based on the first query matrix, the first key matrix, and the first value matrix.

9. The processing system of claim 8, wherein, to generate the regenerated version of the input image, the one or more processors are further configured to execute the computer-executable instructions to cause the processing system to:
generate a second query matrix based on a redacted version of the input image;
generate a second key matrix based on a redacted version of the set of features;
generate a second value matrix based on the dense prediction mask; and
generate the regenerated version of the input image based on the second query matrix, the second key matrix, and the second value matrix.

10. A processor-implemented method, comprising:
accessing an input image;
generating a dense prediction output based on the input image using a dense prediction machine learning (ML) model;
generating a regenerated version of the input image;
generating a first loss based on the input image and a corresponding ground truth dense prediction;
generating a second loss based on the regenerated version of the input image; and
updating one or more parameters of the dense prediction ML model based on the first and second losses.

11. The processor-implemented method of claim 10, wherein generating the regenerated version of the input image comprises:
generating a redacted version of the input image; and
generating, using a regeneration model, the regenerated version of the input image based on the redacted version of the input image and the dense prediction output.

12. The processor-implemented method of claim 11, further comprising updating one or more parameters of the regeneration model based on the second loss.

13. The processor-implemented method of claim 11, wherein generating the redacted version of the input image comprises at least one of:
redacting one or more frequency bands of the input image,
occluding one or more pixels of the input image, or
generating a lower image resolution version of the input image, as compared to an original image resolution of the input image.

14. The processor-implemented method of claim 11, wherein the regeneration model is trained to regenerate the input image by processing the redacted version of the input image conditioned on the dense prediction output.

15. The processor-implemented method of claim 10, wherein the dense prediction output comprises at least one of a semantic segmentation output, a depth estimation output, or a surface normal estimation output.

16. The processor-implemented method of claim 10, wherein the dense prediction ML model comprises a multi-head attention module that generates the dense prediction output based on the input image, a set of features extracted from the input image, and a dense prediction mask generated based on the set of features.

17. The processor-implemented method of claim 16, wherein generating the dense prediction output comprises:
generating a first query matrix based on the dense prediction mask;
generating a first key matrix based on the set of features;
generating a first value matrix based on the input image; and
generating the dense prediction output based on the first query matrix, the first key matrix, and the first value matrix.

18. The processor-implemented method of claim 17, wherein generating the regenerated version of the input image comprises:
generating a second query matrix based on a redacted version of the input image;
generating a second key matrix based on a redacted version of the set of features;
generating a second value matrix based on the dense prediction mask; and
generating the regenerated version of the input image based on the second query matrix, the second key matrix, and the second value matrix.

19. A non-transitory computer-readable medium comprising computer-executable instructions that, when executed by one or more processors of a processing system, cause the processing system to:
access an input image;
generate a dense prediction output based on the input image using a dense prediction machine learning (ML) model;
generate a regenerated version of the input image;
generate a first loss based on the input image and a corresponding ground truth dense prediction;
generate a second loss based on the regenerated version of the input image; and
update one or more parameters of the dense prediction ML model based on the first and second losses.

20. The non-transitory computer-readable medium of claim 19, wherein, to generate the regenerated version of the input image, the non-transitory computer-readable medium further comprises computer-executable instructions that, when executed by the one or more processors of the processing system, cause the processing system to:
generate a redacted version of the input image; and
generate, using a regeneration model, the regenerated version of the input image based on the redacted version of the input image and the dense prediction output.

21. The non-transitory computer-readable medium of claim 20, further comprising computer-executable instructions that, when executed by the one or more processors of the processing system, cause the processing system to update one or more parameters of the regeneration model based on the second loss.

22. The non-transitory computer-readable medium of claim 20, wherein, to generate the redacted version of the input image, the non-transitory computer-readable medium further comprises computer-executable instructions that, when executed by the one or more processors of the processing system, cause the processing system to:
redact one or more frequency bands of the input image,
occlude one or more pixels of the input image, or
generate a lower image resolution version of the input image, as compared to an original image resolution of the input image.

23. The non-transitory computer-readable medium of claim 20, wherein the regeneration model is trained to regenerate the input image by processing the redacted version of the input image conditioned on the dense prediction output.

24. The non-transitory computer-readable medium of claim 19, wherein the dense prediction output comprises at least one of a semantic segmentation output, a depth estimation output, or a surface normal estimation output.

25. The non-transitory computer-readable medium of claim 19, wherein the dense prediction ML model comprises a multi-head attention module that generates the dense prediction output based on the input image, a set of features extracted from the input image, and a dense prediction mask generated based on the set of features.

26. The non-transitory computer-readable medium of claim 25, wherein, to generate the dense prediction output, the non-transitory computer-readable medium further comprises computer-executable instructions that, when executed by the one or more processors of the processing system, cause the processing system to:
generate a first query matrix based on the dense prediction mask;
generate a first key matrix based on the set of features;
generate a first value matrix based on the input image; and
generate the dense prediction output based on the first query matrix, the first key matrix, and the first value matrix.

27. The non-transitory computer-readable medium of claim 26, wherein, to generate the regenerated version of the input image, the non-transitory computer-readable medium further comprises computer-executable instructions that, when executed by the one or more processors of the processing system, cause the processing system to:
generate a second query matrix based on a redacted version of the input image;
generate a second key matrix based on a redacted version of the set of features;
generate a second value matrix based on the dense prediction mask; and
generate the regenerated version of the input image based on the second query matrix, the second key matrix, and the second value matrix.

28. A processing system, comprising:
means for accessing an input image;
means for generating a dense prediction output based on the input image using a dense prediction machine learning (ML) model;
means for generating a regenerated version of the input image;
means for generating a first loss based on the input image and a corresponding ground truth dense prediction;
means for generating a second loss based on the regenerated version of the input image; and
means for updating one or more parameters of the dense prediction ML model based on the first and second losses.

29. The processing system of claim 28, wherein the means for generating the regenerated version of the input image comprise:
means for generating a redacted version of the input image; and
means for generating, using a regeneration model, the regenerated version of the input image based on the redacted version of the input image and the dense prediction output.

30. The processing system of claim 28, wherein:
the means for generating the dense prediction output comprise:
means for generating a first query matrix based on a dense prediction mask generated based on a set of features extracted from the input image;
means for generating a first key matrix based on the set of features;
means for generating a first value matrix based on the input image; and
means for generating the dense prediction output based on the first query matrix, the first key matrix, and the first value matrix; and
the means for generating the regenerated version of the input image comprise:
means for generating a second query matrix based on a redacted version of the input image;
means for generating a second key matrix based on a redacted version of the set of features;
means for generating a second value matrix based on the dense prediction mask; and
means for generating the regenerated version of the input image based on the second query matrix, the second key matrix, and the second value matrix.
